(19) United States
(12) Patent Application Publication
(10) Pub. No.: US 2016/0125427 A1
(43) Pub. Date: May 5, 2016

(54) METHOD AND SYSTEM FOR LINKING PERSONAL NEEDS AND SPEND BEHAVIOR

(71) Applicant: MasterCard International Incorporated, Purchase, NY (US)

(72) Inventors: Kenneth UNSER, Fairfield, CT (US); Jean-Pierre Gerard, Croton-On-Hudson, NY (US)

(73) Assignee: MASTERCARD INTERNATIONAL INCORPORATED, Purchase, NY (US)

(21) Appl. No.: 14/532,442

(22) Filed: Nov. 4, 2014

(51) Int. Cl. G06Q 30/02; G06F 17/30

(52) U.S. Cl. CPC G06Q 30/0201; G06F 17/30876

(57) ABSTRACT

A method for identifying relationships between consumer and merchant service characteristics includes: storing consumer profiles that include consumer characteristics associated with a consumer and transaction data for transactions involving the associated consumer and a specified merchant; storing merchant profiles that include service characteristics associated with a merchant; identifying a group for each consumer characteristic that includes consumer profiles having that consumer characteristic; identifying a group for each service characteristic that includes merchant profiles having that service characteristic; and identifying characteristic relationships that include a consumer characteristic and service characteristic based on transaction data included in consumer profiles in the consumer group of the consumer characteristic that involve merchants associated with merchant profiles in the merchant group of the service characteristic.

### FIELD

The present disclosure relates to the linking of personal needs and spend behavior, specifically the identification of a relationship between consumer personal needs and merchant services based on transaction data and consumer purchase behavior.

### BACKGROUND

Consumers may choose to conduct a payment transaction with a merchant for a variety of reasons. For instance, a consumer may need a product and may choose to purchase it at the closest available merchant, the merchant selling the product for the lowest amount, the merchant with the best reputation for guest service, or a merchant with whom the consumer has a previously established relationship. In such instances, information regarding these types of reasons may be easily identified. For example, evaluating distances from a consumer to merchants or evaluating merchant prices may be identified using existing methods and systems.

However, there may be instances where a consumer may transact with a merchant for additional reasons that are not as easily identified and evaluated. For example, a consumer that is traveling may stay at a specific hotel because they are pet-friendly, because they use specific types of mattresses, or because they have a pool. In another example, a consumer on a road trip may stop at a gas station that has advertised or been rated as having clean bathrooms instead of a competing gas station that lacks any such advertisement. In yet another example, a consumer may choose one restaurant over another due to the availability of food items that satisfy dietary restrictions.

There is a technical problem in that existing computer systems not only fail to obtain the information necessary to identify correlations between consumer personal needs and available services of a merchant, but furthermore lack the programming and resources required to make such identifications. For example, existing systems possess basic consumer knowledge, such as their geographic location, and transaction data, which includes a geographic location for the transaction, and can thus be suitable for identifying patterns regarding consumer travel and purchases. However, these systems are often not configured to store data regarding personal needs and characteristics of consumers, which may comprise sensitive data that must be secured and kept anonymous, let alone perform analysis of such data to identify relationships between personal characteristics and merchant services.

Thus, there is a need for a technical system that is configured to handle sensitive data regarding consumer personal needs and characteristics and that is specially configured to identify relationships between the consumer personal needs and characteristics and merchant services and characteristics based on transaction data for transactions involving the consumers and merchants.

### SUMMARY

The present disclosure provides a description of systems and methods for identifying relationships between consumer characteristics and merchant service characteristics.

A method for identifying relationships between consumer characteristics and merchant service characteristics includes: storing, in a consumer database, a plurality of consumer profiles, wherein each consumer profile includes data related to one or more consumers including one or more consumer characteristics associated with the related one or more consumers and a plurality of transaction data entries, each transaction data entry including data related to a payment transaction involving one or more of the one or more related consumers and including at least a merchant identifier associated with a merchant involved in the related payment transaction and transaction data; storing, in a merchant database, a plurality of merchant profiles, wherein each merchant profile includes data related to a merchant including at least a merchant identifier and one or more service characteristics; identifying, by a processing device, a consumer group for each consumer characteristic of a plurality of consumer characteristics, wherein the consumer group includes a subset of the plurality of consumer profiles, each consumer profile in the subset including the respective consumer characteristic; identifying, by the processing device, a merchant group for each service characteristic of a plurality of service characteristics, wherein the merchant group includes a subset of the plurality of merchant profiles, each merchant profile in the subset including the respective service characteristic; and identifying, by the processing device, one or more characteristic relationships, wherein each characteristic relationship includes a consumer characteristic and a service characteristic and is based on the transaction data included in one or more transaction data entries included in one or more consumer profiles in the consumer group associated with the consumer characteristic that include a merchant identifier included in a merchant profile included in the merchant group associated with the service characteristic.

A system for identifying relationships between consumer characteristics and merchant service characteristics includes a consumer database, a merchant database, and a processing device. The consumer database is configured to store a plurality of consumer profiles, wherein each consumer profile includes data related to one or more consumers including one or more consumer characteristics associated with the related one or more consumers and a plurality of transaction data entries, each transaction data entry including data related to a payment transaction involving one or more of the one or more related consumers and including at least a merchant identifier associated with a merchant involved in the related payment transaction and transaction data. The merchant database is configured to store a plurality of merchant profiles, wherein each merchant profile includes data related to a merchant including at least a merchant identifier and one or more service characteristics. The processing device is configured to: identify a consumer group for each consumer characteristic of a plurality of consumer characteristics, wherein the consumer group includes a subset of the plurality of consumer profiles, each consumer profile in the subset including the respective consumer characteristic; identify a merchant group for each service characteristic of a plurality of service characteristics, wherein the merchant group includes a subset of the plurality of merchant profiles, each merchant profile in the subset including the respective service characteristic; and identify one or more characteristic relationships, wherein each characteristic relationship includes a consumer characteristic and a service characteristic and is based on the transaction data included in one or more transaction data entries included in one or more consumer profiles in the consumer group associated with the consumer characteristic that include a merchant identifier included in a merchant profile included in the merchant group associated with the service characteristic.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying relationships between consumer and merchant characteristics in accordance with exemplary embodiments.

FIG. 2 is a block diagram illustrating the processing server of FIG. 1 for the identification of relationships between consumer characteristics and merchant service characteristics with exemplary embodiments.

FIG. 3 is a flow diagram illustrating a process for identifying consumer characteristics related to requested merchant service characteristics based on transaction data in accordance with exemplary embodiments.

FIG. 4 is a flow chart illustrating an exemplary method for identifying relationships between consumer characteristics and merchant service characteristics in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Identifying Relationships Between Consumer and Merchant Characteristics

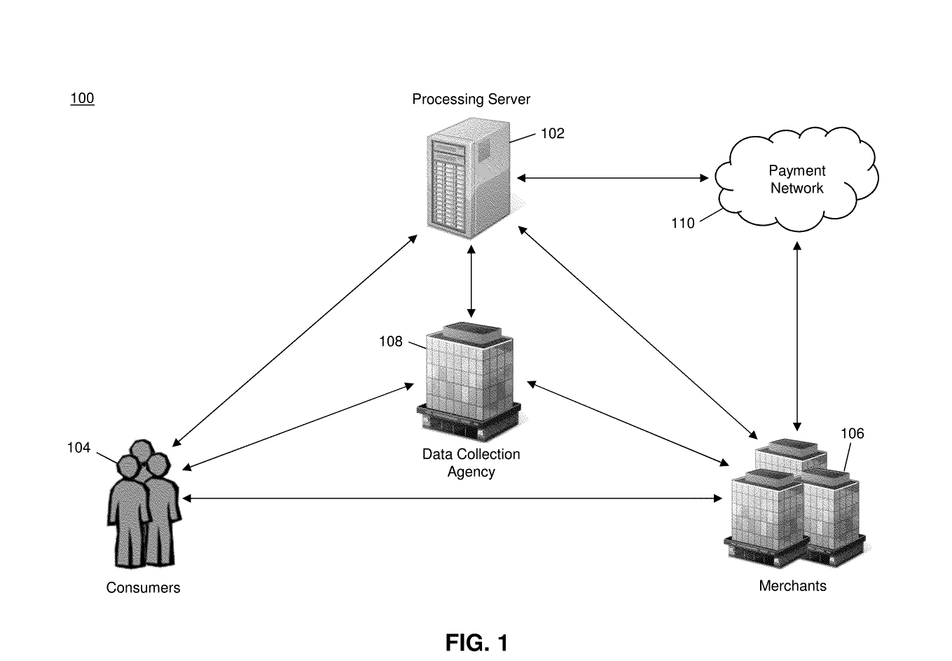

FIG. 1 illustrates a system 100 for the identification of relationships between consumer characteristics and merchant service characteristics based on spend behavior and purchase data.

The system 100 may include a processing server 102. The processing server 102, discussed in more detail below, may be configured to identify relationships between consumer characteristics and merchant service characteristics. Consumer characteristics may include personal needs, such as pet service needs, children service needs, restroom needs, vehicle service needs, resting needs, dietary needs, etc. For example, a consumer may have two cats, a child, and may require a gluten-free diet, and may have consumer characteristics associated therewith accordingly. Consumer characteristics may also include demographic characteristics (e.g., age, gender, marital status, familial status, residential status, education, occupation, income, zip code, postal code, etc.).

Merchant service characteristics can include pet services, child services, parking availability, scenic area, rest area, fuel services, car wash, vehicle services, convenience services, restroom characteristics, hotel characteristics, food characteristics, etc. For example, a merchant gas station may sell specific types of fuel (e.g., unleaded, premium unleaded, diesel, electric), may have a specific type of car wash (e.g., touchless), and may have specific restroom characteristics associated therewith, such as a specified level of cleanliness, gender-separate restrooms, and single-occupancy restrooms.

The processing server 102 may be configured, as discussed in more detail below, to identify relationships between the consumer characteristics and the merchant service characteristics based on transaction data. Consumers 104 may conduct payment transactions with merchants 106. Payment transactions may be conducted by a payment network 110, which may be configured to forward transaction data for the payment transactions to the processing server 102. The processing server 102 may receive the transaction data and use it to identify relationships between the consumer and merchant characteristics using methods and systems discussed herein. In some embodiments, the processing server 102 may be a part of the payment network 110, and, in further embodiments, may be configured to process the payment transaction involving the consumers 104 and merchants 106.

The processing server 102 may store data associated with the consumers 104 and merchants 106, such as consumer characteristics and merchant service characteristics, respectively. The processing server 102 may receive the data directly from the consumers 104 and merchants 106 using methods and systems that will be apparent to persons having skill in the relevant art, such as surveys. In some instances, the processing server 102 may receive the data from a data collection agency 108. The data collection agency 108 may be an entity configured to collect consumer characteristic data from consumers 104 and merchant service characteristic data from merchants 106 that is also configured to make the data available to the processing server 102.

The processing server 102 may receive and store the collected data, and may ensure that consumer privacy and security are maintained. In some embodiments, consumer characteristic data may not include any personally identifiable information without consent of the corresponding consumer 104. For example, the processing server 102 may only include consumer characteristics and an identifier associated with a transaction account to which the characteristics are associated, such that the characteristics are not identifiable as to any consumer 104 and can be associated with payment transactions involving the associated transaction account.

The processing server 102 may identify relationships between the consumer characteristics and merchant service characteristics based on the transaction data. As discussed in more detail below, the processing server 102 may identify each transaction account associated with a specific consumer characteristic and the transaction data associated therein, may identify each merchant 106 associated with a specific merchant service characteristic, and may identify relationships based on the transaction data for each consumer characteristic for transactions that involve or do not involve the merchants associated with a given merchant service characteristic.

For example, consumers that have pets may regularly transact at more hotels that are pet friendly based on the transaction data associated with consumer characteristics that indicate pets. In another example, consumers that have dietary restrictions may prefer to transact at restaurants whose food characteristics are readily advertised over restaurants who may also accommodate their dietary restrictions but do not advertise the information. In another example, consumers with children may prefer gas stations with family restrooms over gas stations with unisex restrooms. In yet another example, consumers of certain demographics may be identified as preferring hotels with pools over hotels without pools.

In some embodiments, the processing server 102 may also be configured to make recommendations based on characteristic relationships. For instance, the processing server 102 may identify a relationship between a target market of consumers 104 for a merchant 106 and specific merchant service characteristics. The processing server 102 may then recommend the specific merchant service characteristics to the merchant 106 in order to attract consumers 104 in the target market. For example, a hotel chain may want to attract more married couples traveling without children. The processing server 102 may identify relationships between married couples traveling without children and hotels that have hot tubs and hotels that are pet friendly. The processing server 102 may thus recommend that the hotel chain begin to accommodate pets and add hot tubs to their amenities in an effort to attract the target consumers 104.

The methods and systems discussed herein may enable the processing server 102 to identify relationships between consumer characteristics and merchant service characteristics based on consumer transaction data and spend behavior. The processing server 102 may be configured to obtain data that is not gathered using existing systems and may be specially configured to identify relationships between the data, and may also be further configured to analyze the identified relationships to form conclusions, such as recommendations for the offering or removal of merchant services. Such identification and analysis may be unable to be performed using existing methods and systems without significant modification to technical hardware, system communications, and system programming.

### Processing Server

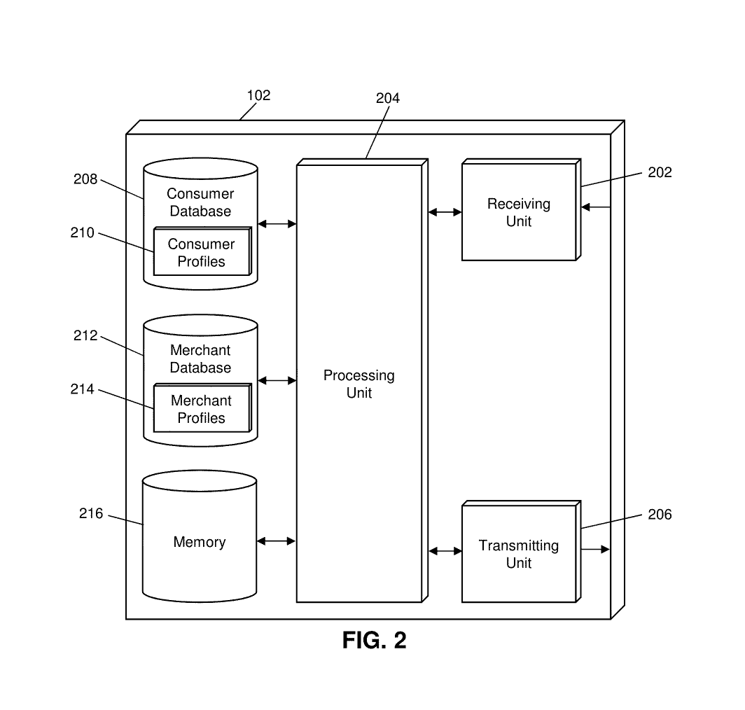

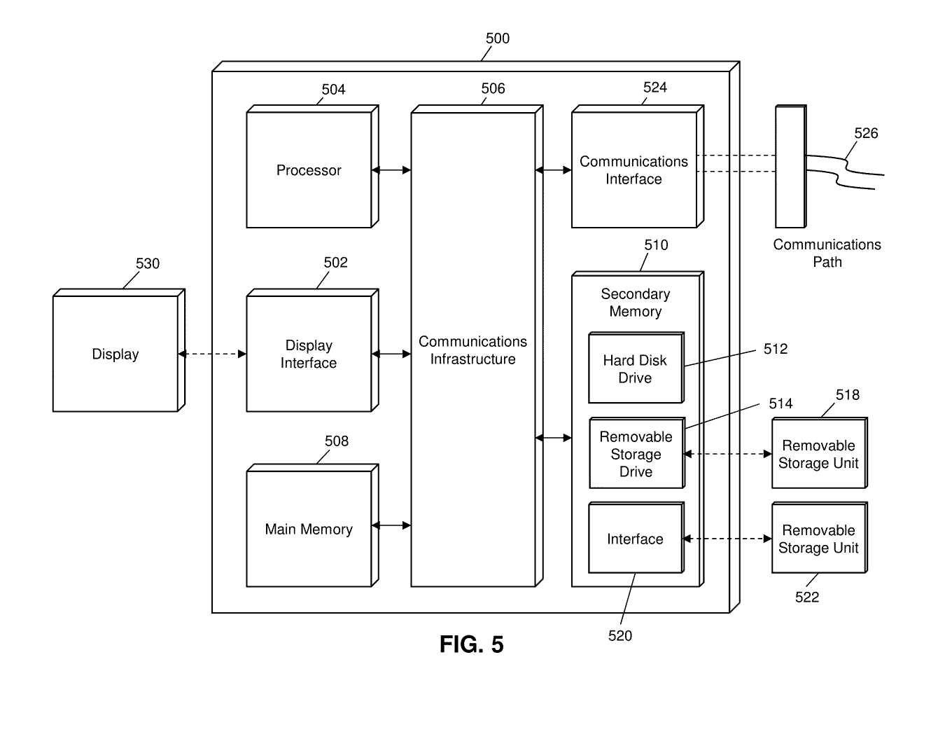

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving unit 202. The receiving unit 202 may be configured to receive data over one or more networks via one or more network protocols. The receiving unit 202 may be configured to receive transaction data from the payment network 110, and may also be configure to receive consumer characteristics and merchant service characteristics from consumers 104, merchants 106, data collection agencies 108, and other entities as will be apparent to persons having skill in the relevant art.

The processing server 102 may further include a consumer database 208. The consumer database 208 may be configured to store a plurality of consumer profiles 210, with each consumer profile 210 including data related to one or more consumers 104. Each consumer profile 210 may include one or more consumer characteristics and may also include a plurality of transaction data entries for payment transactions involving the related one or more consumers 104. Each transaction data entry may include at least a merchant identifier associated with a merchant 106 involved in the respective payment transaction and transaction data. The transaction data may include, for instance, transaction amount, transaction time and/or date, geographic location, consumer data, merchant data, product data, offer data, point of sale data, etc.

The consumer characteristics, as discussed above, may include demographic characteristics, financial characteristics, consumer preferences, personal needs, and any other data suitable for use in performing the functions disclosed herein. In an exemplary embodiment, such information may be obtained with explicit consent of the associated consumer 104. For instance, the associated consumer 104 may opt-in to a service provided by the processing server 102. In other embodiments, consumer characteristics may not include any personally identifiable information of the associated consumer 104. Personal needs may include pet service needs (e.g., dogs, cats, birds, etc.), child service needs (e.g., diaper changing facilities, family restrooms, etc.), restroom needs (e.g., private stalls, single-occupancy restrooms, family restrooms, western-style toilets, etc.), vehicle service needs (e.g., RV hook-ups, electric charging station, unleaded fuel, diesel fuel, oil change, air, vacuum, tire services, etc.), resting needs (e.g., rest area, scenic area, picnic area, king-sized beds, double beds, shower facilities, etc.), dietary needs (e.g., vegan, vegetarian, gluten-free, peanut-free, etc.), and other personal needs that will be apparent to persons having skill in the relevant art.

The processing server 102 may also include a merchant database 212. The merchant database 212 may be configured to store a plurality of merchant profiles 214. Each merchant profile 214 may include data related to a merchant 106 including at least a merchant identifier associated with the merchant and one or more service characteristics. The merchant identifier may be a unique value suitable for use in identification of the associated merchant 106 and/or the respective merchant profile 214, such as a merchant identification number, registration number, point of sale identifier, or other suitable value that will be apparent to persons having skill in the relevant art.

The service characteristics may include characteristics associated with personal services offered by the related merchant 106. For example, service characteristics may include pet services (e.g., pet-friendly rooms, walking areas, pet bathing areas, dog runs, etc.), child services (e.g., diaper changing stations, family restrooms, recreation areas, etc.), parking availability (e.g., RV parking, trailer parking, motorcycle parking, etc.), picnic area, scenic area, rest area, fuel services (e.g., unleaded fuel, diesel fuel, electric charging station, etc.), car wash (e.g., full service, self-service, touchless, etc.), vehicle services (e.g., air, vacuum, oil change, tire rotation, etc.), convenience services, restroom characteristics (e.g., unisex, family, single-occupancy, private stalls, cleanliness, advertised cleanliness, etc.), hotel characteristics (e.g., hotel amenities, room amenities, room types, etc.), food characteristics (e.g., dietary restrictions, cuisine type, pricing, etc.), and other service characteristics that will be apparent to persons having skill in the relevant art.

Service characteristics may be obtained by the processing server 102 via a variety of methods and systems that will be apparent to persons having skill in the relevant art. For instance, consumers 104 and merchants 106 may fill out surveys regarding merchant service characteristics, crowd sourcing of service characteristics could be used (e.g., by a plurality of consumers 104 indicating service characteristics of a merchant 106 via device application programs and web sites), merchants 106 may self-report their service characteristics, users or entities associated with the processing server 102 or data collection agency 108 may visit the merchant 106 and report on service characteristics, etc. Such data may be received by the receiving unit 202 of the processing server 102. In some embodiments, the processing server 102 may include an input unit, such as a keyboard, mouse, touch screen, microphone, camera, etc., which may be used to input service characteristic data into the processing server 102 for storage in the merchant database 212. Similar methods for gathering data may be used in the gathering of consumer characteristics stored in the consumer database 208.

The processing server 102 may also include a processing unit 204. The processing unit 204 may be configured to perform the functions of the processing server 102 discussed herein as will be apparent to persons having skill in the relevant art. The processing unit 204 may be configured to identify a consumer group for each consumer characteristic. Each consumer group may include a subset of the plurality of consumer profiles 210 in the consumer database 208, with each consumer profile 210 in the group including the respective consumer characteristic. The processing unit 204 may also be configured to identify a merchant group for each service characteristic, with each merchant group including a subset of the merchant profiles 214 of the merchant database 212 of merchant profiles 214 that include the respective service characteristic.

The processing unit 204 may be further configured to identify one or more characteristic relationships. Each characteristic relationship may include a consumer characteristic and a service characteristic, and may be identified based on the transaction data included in transaction data entries in the consumer profiles 210 in the consumer group for the consumer characteristic for payment transaction that include and/or do not include merchants 106 associated with merchant profiles 214 in the merchant group for the service characteristic. The processing unit 204 may use any suitable type of method for identifying relationships between the characteristics, such as testing assumptions, applying regression to the transaction data, using one or more rules or algorithms, etc.

For instance, the processing unit 204 may identify an assumption (e.g., such as input by an operator of the processing server 102 via an input unit) and may test that assumption to identify if it is accurate. For example, the processing unit 204 may test an assumption that pet owners select a gas station based on the availability of a pet-friendly walking area, by identifying consumers 104 and merchant gas stations and identifying if consumers 104 whose consumer characteristics include being a pet owner select gas stations whose service characteristics include pet-friendly walking areas more than other gas stations. In another example, linear, logarithmic, or other types of regression may be used for combinations of service characteristics and consumer characteristics to identify if correlations exist. For instance, merchants 106 with individually locking restrooms may experience an increase in revenue from consumers 104 with small children that is quantifiable via linear regression.

In some embodiments, the processing unit 204 may also be configured to identify recommendations based on identified relationships. For example, the processing unit 204 may identify recommendations for merchant services for a merchant 106 based on existing merchant services (e.g., identified by the merchant 106 or in a merchant profile 214 associated with the merchant 106) and based on identified relationships between service characteristics and consumer characteristics. For instance, the processing unit 204 may recommend that a merchant gas station add an electric charging station due to a high consumer need for electric charging stations and a lack of availability in the geographic area surrounding the gas station. In another example, the processing unit 204 may recommend that a merchant restaurant advertise vegan-friendly foods based on relationships between consumers that regularly visit restaurants and the visibility of such advertisements.

The processing server 102 may also include a transmitting unit 206. The transmitting unit 206 may be configured to transmit data over one or more networks via one or more network protocols. The transmitting unit 206 may be configured to transmit characteristic relationships, recommendations, and other suitable data from the processing server 102 to a suitable entity, such as merchants 106, the payment network 110, data collection agency 108, etc. In some embodiments, transmissions by the transmitting unit 206 may be in response to one or more requests received by the receiving unit 202.

The processing server 102 may further include a memory 216. The memory 216 may be configured to store data suitable for performing the functions disclosed herein. For example, the memory 216 may be configured to store one or more rules or algorithms for the identification of the characteristic relationships and/or for making recommendations based on characteristic relationships, data regarding consumer or service characteristics, geographic data, advertising data, and other suitable data that will be apparent to persons having skill in the relevant art.

### Process for Identifying Characteristic Relationships

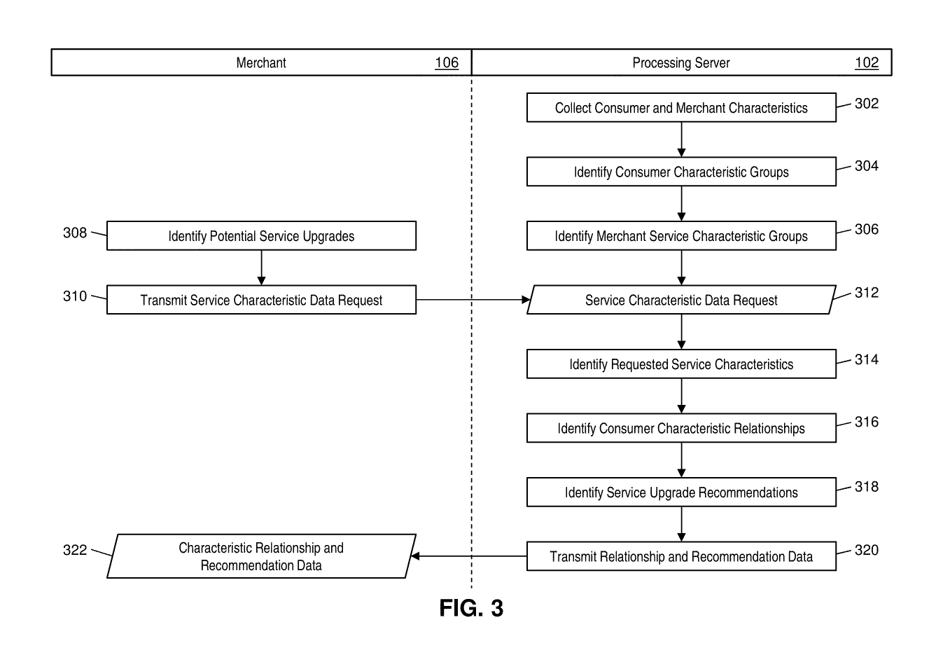

FIG. 3 illustrates a process for the identification of relationships between consumer characteristics and specified service characteristics and analysis of recommendations thereof.

In step 302, the receiving unit 202 of the processing server 102 may receive consumer characteristics and merchant service characteristics, such as from the consumers 104, merchants 106, and data collection agency 108. The processing unit 204 of the processing server 102 may store the consumer characteristics in consumer profiles 210 in the consumer database 208 that include transaction data for payment transactions involving a related consumer 104, and may store the merchant service characteristics in merchant profiles 214 in the merchant database 212.

In step 304, the processing unit 204 may identify consumer characteristic groups. Each consumer characteristic group may include a plurality of consumer profiles 210 that include the respective consumer characteristic. In step 306, the processing unit 204 may identify merchant service characteristic groups. Each merchant service characteristic group may include a plurality of merchant profiles 214 that include the respective merchant service characteristic.

In step 308, a merchant 106 may identify potential service upgrades or changes that they are contemplating making. For example, a hotel may identify the potential to add a pool, to become pet friendly, and to add a restaurant. In step 310, the merchant 106 may transmit a request for service characteristic data to the processing server 102. In step 312, the receiving unit 202 of the processing server 102 may receive the service characteristic data request. The service characteristic data request may include at least the service characteristics identified by the merchant 106 that the merchant 106 may be interested in.

In step 314, the processing unit 204 may identify the previously identified merchant service characteristic groups that are associated with the service characteristics included in the received service characteristic data request. In step 316, the processing unit 204 may identify characteristic relationships between the service characteristics included in the request and the consumer characteristics based on transaction data included in each consumer characteristic group that includes and does not include merchants included in the respective merchant service characteristic groups. For instance, in the example with the hotel requesting data regarding the addition of a pool or restaurant or conversion to a pet-friendly hotel, the processing unit 204 may identify that hotels with pools have a strong relationship with consumers that travel with children (e.g., consumers that travel with children may prefer hotels with pools over hotels without pools), but that there is no significant increase in revenue for such properties once a pool has been added; hotels with restaurants have a strong relationship with consumers in general over hotels without restaurants and also have a strong relationship with consumers on business travel, both of which lead to increased revenue; and that hotels that are pet-friendly have a strong relationship with consumers who have pets regardless of if they travel with their pets or not. In some instances, relationships may also be based on multiple service characteristics or merchant data points, such as geographic location. For instance, in the example of the hotel requesting data regarding the addition of a pool, the processing unit 204 may identify relationships between hotels with pools and consumers in geographic locations similar to the one where the hotel is located, such as based on climate, population, etc. For example, a hotel in northern Michigan may have less of an increase in revenue from the addition of a pool as a hotel in southern Florida.

In step 318, the processing unit 204 may identify recommendations for service upgrades for the merchant 106 based on the identified relationships. For instance, in the above example, the processing unit 204 may recommend the addition of a restaurant to the property due to the increased revenue, and may also recommend the conversion to being pet-friendly dependent on cost, but may not recommend the addition of a pool due to an unlikelihood that costs of such an addition would be recuperated.

In step 320, the transmitting unit 206 of the processing server 102 may transmit the relationship data and recommendations to the merchant 106. In step 322, the merchant 106 may receive the data and recommendations, and may proceed accordingly. In the above example, the hotel may decide to build the restaurant addition, but may refrain from conversion to a pet-friendly hotel due to associated costs, such as housekeeping and landscaping required for suitable pet areas.

### Exemplary Method for Identifying Relationships Between Consumer Characteristics and Merchant Service Characteristics

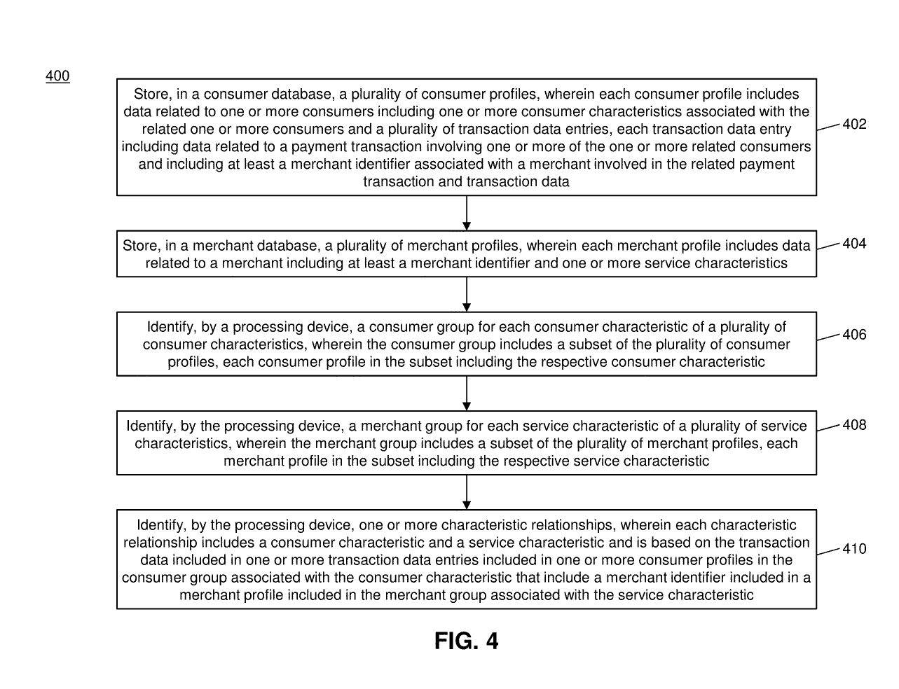

FIG. 4 illustrates a method 400 for the identification of relationships between consumer characteristics and merchant service characteristics based on consumer transaction and spend data.

In step 402, a plurality of consumer profiles (e.g., consumer profiles 210) may be stored in a consumer database (e.g., the consumer database 208), wherein each consumer profile 210 includes data related to one or more consumers (e.g., consumers 104) including one or more consumer characteristics associated with the related one or more consumers 104 and a plurality of transaction data entries, each transaction data entry including data related to a payment transaction involving one or more of the one or more related consumers 104 and including at least a merchant identifier associated with a merchant (e.g., a merchant 106) involved in the related payment transaction and transaction data. In some embodiments, the consumer profiles 210 may include data related to consumers 104 that have provided consent for the gathering and storage of associated data. In one embodiment, the plurality of consumer characteristics includes at least one of: demographic characteristics and personal needs. In a further embodiment, the personal needs may include at least one of: pet service needs, children service needs, restroom needs, vehicle service needs, resting needs, and dietary needs.

In step 404, a plurality of merchant profiles (e.g., merchant profiles 214) may be stored in a merchant database (e.g., the merchant database 212), wherein each merchant profile 214 includes data related to a merchant 106 including at least a merchant identifier and one or more service characteristics. In one embodiment, the plurality of service characteristics may include at least one of: pet services, child services, parking availability, picnic area, scenic area, rest area, fuel services, car wash, vehicle services, convenience services, restroom characteristics, hotel characteristics, and food characteristics.

In step 406, a consumer group may be identified by a processing device (e.g., the processing unit 204) for each consumer characteristic of a plurality of consumer characteristics, wherein the consumer group includes a subset of the plurality of consumer profiles, each consumer profile 210 in the subset including the respective consumer characteristic. In some embodiments, each consumer group may be associated with two or more consumer characteristics and where each consumer profile 210 in the subset includes the two associated two or more consumer characteristics.

In step 408, a merchant group may be identified by the processing device 204 for each service characteristic of a plurality of service characteristics, wherein the merchant group includes a subset of the plurality of merchant profiles, each merchant profile 214 in the subset including the respective service characteristic. In some embodiments, each merchant group may be associated with two or more service characteristics and each merchant profile 214 in the subset includes the two associated two or more service characteristics.

In step 410, one or more characteristic relationships may be identified by the processing device 204, wherein each characteristic relationship includes a consumer characteristic and a service characteristic and is based on the transaction data included in one or more transaction data entries included in one or more consumer profiles 210 in the consumer group associated with the consumer characteristic that include a merchant identifier included in a merchant profile 214 in the merchant group associated with the service characteristic. In one embodiment, the method 400 may further include: receiving, by a receiving device (e.g., the receiving unit 202), a request for characteristic relationships; and transmitting, by a transmitting device (e.g., the transmitting unit 206), the identified one or more characteristic relationships in response to the received request for characteristic relationships.

In some embodiments, each identified characteristic relationship may be further based on a comparison of: the transaction data included in one or more transaction data entries included in one or more consumer profiles in the consumer group associated with the consumer characteristic that include a merchant identifier included in a merchant profile included in the merchant group associated with the service characteristic; with the transaction data included in one or more transaction data entries included in one or more consumer profiles in the consumer group associated with the consumer characteristic that include a merchant identifier not included in a merchant profile included in the merchant group associated with the service characteristic.

In one embodiment, the method 400 may further include: receiving, by the receiving device 202, a request for services recommendation, wherein the request for services recommendation includes at least a specific merchant identifier; identifying, by the processing device 204, a recommended service characteristic based on the transaction data included in the transaction data entries included in the consumer profiles 210 in the consumer group associated with the consumer characteristic included in each of the identified one or more characteristic relationships that includes a service characteristic not included in a specific merchant profile 214 that includes the specific merchant identifier; and transmitting, by the transmitting device 206, the identified recommended service characteristic in response to the request for services recommendation.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

Techniques consistent with the present disclosure provide, among other features, systems and methods for identifying relationships between consumer characteristics and merchant service characteristics. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying relationships between consumer characteristics and merchant service characteristics, comprising:
storing, in a consumer database, a plurality of consumer profiles, wherein each consumer profile includes data related to one or more consumers including one or more consumer characteristics associated with the related one or more consumers and a plurality of transaction data entries, each transaction data entry including data related to a payment transaction involving one or more of the one or more related consumers and including at least a merchant identifier associated with a merchant involved in the related payment transaction and transaction data;
storing, in a merchant database, a plurality of merchant profiles, wherein each merchant profile includes data related to a merchant including at least a merchant identifier and one or more service characteristics;
identifying, by a processing device, a consumer group for each consumer characteristic of a plurality of consumer characteristics, wherein the consumer group includes a subset of the plurality of consumer profiles, each consumer profile in the subset including the respective consumer characteristic;
identifying, by the processing device, a merchant group for each service characteristic of a plurality of service characteristics, wherein the merchant group includes a subset of the plurality of merchant profiles, each merchant profile in the subset including the respective service characteristic; and
identifying, by the processing device, one or more characteristic relationships, wherein each characteristic relationship includes a consumer characteristic and a service characteristic and is based on the transaction data included in one or more transaction data entries included in one or more consumer profiles in the consumer group associated with the consumer characteristic that include a merchant identifier included in a merchant profile included in the merchant group associated with the service characteristic.

2. The method of claim 1, wherein each identified characteristic relationship is further based on a comparison of
the transaction data included in one or more transaction data entries included in one or more consumer profiles in the consumer group associated with the consumer characteristic that include a merchant identifier included in a merchant profile included in the merchant group associated with the service characteristic, with
the transaction data included in one or more transaction data entries included in one or more consumer profiles in the consumer group associated with the consumer characteristic that include a merchant identifier not included in a merchant profile included in the merchant group associated with the service characteristic.

3. The method of claim 1, wherein each consumer group is associated with two or more consumer characteristics and where each consumer profile included in the included subset includes the two associated two or more consumer characteristics.

4. The method of claim 1, wherein each merchant group is associated with two or more service characteristics and where each merchant profile included in the included subset includes the two associated two or more service characteristics.

5. The method of claim 1, further comprising:
receiving, by a receiving device, a request for characteristic relationships; and
transmitting, by a transmitting device, the identified one or more characteristic relationships in response to the received request for characteristic relationships.

6. The method of claim 5, wherein
the request for characteristic relationships further includes a specific service characteristic, and
each of the identified one or more characteristic relationships includes the specific service characteristic.

7. The method of claim 1, further comprising:
receiving, by a receiving device, a request for services recommendation, wherein the request for services recommendation includes at least a specific merchant identifier;
identifying, by the processing device, a recommended service characteristic based on the transaction data included in the transaction data entries included in the consumer profiles in the consumer group associated with the consumer characteristic included in each of the identified one or more characteristic relationships that includes a service characteristic not included in a specific merchant profile that includes the specific merchant identifier; and
transmitting, by a transmitting device, the identified recommended service characteristic in response to the request for services recommendation.

8. The method of claim 1, wherein the plurality of consumer characteristics includes at least one of: demographic characteristics and personal needs.

9. The method of claim 8, wherein personal needs includes at least one of:
pet service needs, children service needs, restroom needs, vehicle service needs, resting needs, and dietary needs.

10. The method of claim 1, wherein the plurality of service characteristics includes at least one of: pet services, child services, parking availability, picnic area, scenic area, rest area, fuel services, car wash, vehicle services, convenience services, restroom characteristics, hotel characteristics, and food characteristics.

11. A system for identifying relationships between consumer characteristics and merchant service characteristics, comprising:
a consumer database configured to store a plurality of consumer profiles, wherein each consumer profile includes data related to one or more consumers including one or more consumer characteristics associated with the related one or more consumers and a plurality of transaction data entries, each transaction data entry including data related to a payment transaction involving one or more of the one or more related consumers and including at least a merchant identifier associated with a merchant involved in the related payment transaction and transaction data;
a merchant database configured to store a plurality of merchant profiles, wherein each merchant profile includes data related to a merchant including at least a merchant identifier and one or more service characteristics; and
a processing device configured to
identify a consumer group for each consumer characteristic of a plurality of consumer characteristics, wherein the consumer group includes a subset of the plurality of consumer profiles, each consumer profile in the subset including the respective consumer characteristic,
identify a merchant group for each service characteristic of a plurality of service characteristics, wherein the merchant group includes a subset of the plurality of merchant profiles, each merchant profile in the subset including the respective service characteristic, and
identify one or more characteristic relationships, wherein each characteristic relationship includes a consumer characteristic and a service characteristic and is based on the transaction data included in one or more transaction data entries included in one or more consumer profiles in the consumer group associated with the consumer characteristic that include a merchant identifier included in a merchant profile included in the merchant group associated with the service characteristic.

12. The system of claim 11, wherein each identified characteristic relationship is further based on a comparison of
the transaction data included in one or more transaction data entries included in one or more consumer profiles in the consumer group associated with the consumer characteristic that include a merchant identifier included in a merchant profile included in the merchant group associated with the service characteristic, with
the transaction data included in one or more transaction data entries included in one or more consumer profiles in the consumer group associated with the consumer characteristic that include a merchant identifier not included in a merchant profile included in the merchant group associated with the service characteristic.

13. The system of claim 11, wherein each consumer group is associated with two or more consumer characteristics and where each consumer profile included in the included subset includes the two associated two or more consumer characteristics.

14. The system of claim 11, wherein each merchant group is associated with two or more service characteristics and where each merchant profile included in the included subset includes the two associated two or more service characteristics.

15. The system of claim 11, further comprising:
a receiving device configured to receive a request for characteristic relationships; and
a transmitting device configured to transmit the identified one or more characteristic relationships in response to the received request for characteristic relationships.

16. The system of claim 15, wherein
the request for characteristic relationships further includes a specific service characteristic, and
each of the identified one or more characteristic relationships includes the specific service characteristic.

17. The system of claim 11, further comprising:
a transmitting device; and
a receiving device configured to receive a request for services recommendation, wherein the request for services recommendation includes at least a specific merchant identifier, wherein
the processing device is further configured to identify a recommended service characteristic based on the transaction data included in the transaction data entries included in the consumer profiles in the consumer group associated with the consumer characteristic included in each of the identified one or more characteristic relationships that includes a service characteristic not included in a specific merchant profile that includes the specific merchant identifier, and
the transmitting device is configured to transmit the identified recommended service characteristic in response to the request for services recommendation.

18. The system of claim 11, wherein the plurality of consumer characteristics includes at least one of: demographic characteristics and personal needs.

19. The system of claim 18, wherein personal needs includes at least one of: pet service needs, children service needs, restroom needs, vehicle service needs, resting needs, and dietary needs.

20. The system of claim 11, wherein the plurality of service characteristics includes at least one of: pet services, child services, parking availability, picnic area, scenic area, rest area, fuel services, car wash, vehicle services, convenience services, restroom characteristics, hotel characteristics, and food characteristics.
